(19) United States
(12) Patent Application Publication
(10) Pub. No.: US 2005/0000769 A1
(43) Pub. Date: Jan. 6, 2005

(54) Arrangement for providing a vacuum for the brake power assist unit of a motor vehicle

(76) Inventors: Juergen Hawener, Ludwigsburg (DE); Helmut Schulz, Tiefenbronn (DE); Thomas Hardt, Weinstadt (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/687,936

(22) Filed: Oct. 20, 2003

(30) Foreign Application Priority Data
Oct. 19, 2002 (DE) 102 48 848.7

(51) Int. Cl. B60T 11/00

(52) U.S. Cl. 188/356

(57) ABSTRACT

An arrangement is provided for providing a vacuum for the brake power assist unit of a motor vehicle having a vacuum pump which can be connected as required as a function of the operating conditions, and at least one other additional pump being provided for the buildup of a sufficient vacuum in the brake power assist unit. The additional pump is a secondary air pump already present in the vehicle, the controlling of the vacuum pump taking place simultaneously with the switching-on of the secondary air pump.

### BACKGROUND AND SUMMARY OF THE INVENTION

This application claims the priority of Application No. 102 48 848.7, filed Oct. 19, 2002, in Germany, the disclosure of which is expressly incorporated by reference herein.

The invention relates to an arrangement for providing a vacuum for the brake power assist unit of a motor vehicle having a vacuum pump which can be connected as required as a function of the operating conditions, and at least one other pump existing for the buildup of a sufficient vacuum in the brake power assist unit. Such an arrangement is known from German Patent Document DE 199 39 200 A1. In this known document, it is important that the pressure is reliably provided in a pressure reservoir of the motor vehicle. For this purpose, a first pump as well as additional pump for generating pressure independently of the first pump are provided. For this purpose, the pumps are preferably arranged parallel to one another and can be controlled independently of one another.

Based on the state of the art, it is an object of the present invention to find a simple and cost-effective implementation which, on the one hand, reduces the expenditures for generating pressure and simultaneously provides a corresponding pressure for the brake power assist unit in a highly reliable manner.

According to the invention, this object is achieved by providing an arrangement for providing a vacuum for the brake power assist unit of a motor vehicle having a vacuum pump which can be connected as required as a function of the operating conditions, at least one other additional pump being provided for the buildup of a sufficient vacuum in the brake power assist unit, wherein the additional pump is a secondary air pump, the controlling of the vacuum pump taking place simultaneously with the switching-on of the secondary air pump.

Thus the utilization of the already existing secondary air pump as an additional pump has the advantage that no additional component has to be provided. The controlling of the two pumps simultaneously also permits the elimination of a separate control unit for the vacuum air pump. This advantage is the result of the fact that the secondary air pump is switched on anyhow during the cold start. This advantageous joint switching of the two pumps is a result of the fact that the problem of the lack of an intake vacuum occurs after the cold starting during the cold heating measures, thus, simultaneously with the operation of the secondary air pump.

In the case of this advantageous arrangement, an additional control unit for controlling the vacuum pump is not necessary. At the same time, no change at the motor control unit is required because the switching operation for switching the secondary air pump on and off respectively is simultaneously utilized for the vacuum air pump. The therefore simple electrical cabling also has the advantage that the solution is cost-effective.

As a result of the measures described herein and in the claims, advantageous further developments of the object of the invention are permitted.

Thus, the arrangement of the vacuum air pump and the secondary air pump as one component has the advantage that the space requirement in the vehicle is further minimized.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram of an arrangement for the joint controlling of a secondary air pump and for a vacuum pump for providing a vacuum operating braking power assist unit constructed according to a preferred embodiment of the present invention; and

FIG. 2 is a schematic diagram of an arrangement of a secondary air pump and vacuum pump combined in a component for providing a vacuum operated brake power assist unit constructed according to another preferred embodiment of the present invention.

### DETAILED DESCRIPTIONS OF THE DRAWINGS

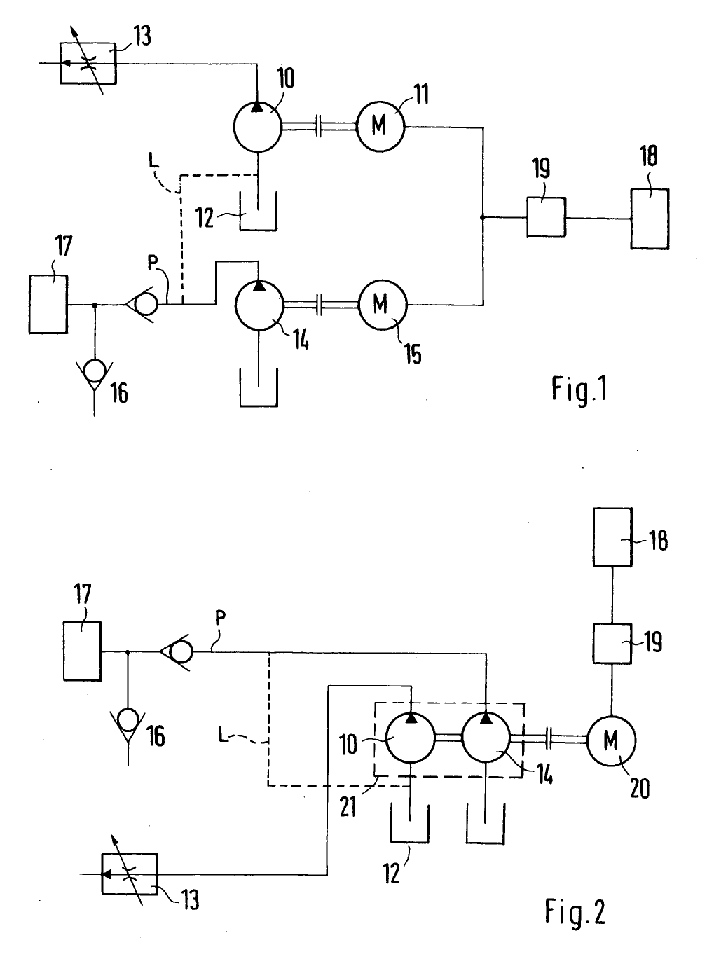

FIG. 1 illustrates an arrangement for the joint controlling of a secondary air pump 10 and a vacuum pump by means of a joint control unit for providing a vacuum operated braking power assist unit. The electric secondary air pump 10 is controlled by a motor 11 and provides that, in the switched-on condition, air is taken in by way of an air filter 12 and is blown into the outlet of the schematically depicted motor section 13. Parallel to the secondary air pump 10, an electric vacuum pump 14, which is controlled by a motor 15, is arranged such that it provides a vacuum for a brake power assist unit 17 by way of a suction pipe. Line L is disposed to be selectively opened to pipe P to provide a vacuum assist from the secondary air pump 10. The controlling of the motors 11 and 15 takes place by means of a motor control unit 18 which is connected by way of a relay 19 with the parallel connection of the motors 11 and 12 and thus the secondary air pump section and the vacuum pump section. As a result, it is ensured that, when the operation of the secondary air pump is started, the vacuum pump is also switched on. As explained initially, this makes sense because, normally, when the motor is cold, thus when the secondary air pump is required, the vacuum for the brake power assist unit is also not present.

FIG. 2 illustrates another embodiment which shows an arrangement of the secondary air pump 10 and the vacuum pump 14 in a combined fashion. In this figure, identical components are provided with the same reference numbers but, in contrast to FIG. 1, the secondary air pump 10 and the vacuum pump 14 are combined here to one component 21. As a result, the arrangement of the two pumps can take place in a more space-saving manner, and the pumps can be operated by a single driving motor 20 for both pumps.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof

1. Arrangement for providing a vacuum for the brake power assist unit of a motor vehicle having a vacuum pump which can be connected as required as a function of the operating conditions, at least one other additional pump being provided for the buildup of a sufficient vacuum in the brake power assist unit,
wherein the additional pump is a secondary air pump, the controlling of the vacuum pump taking place simultaneously with the switching-on of the secondary air pump.

2. Arrangement according to claim 1, wherein the vacuum pump and the secondary air pump are switched in parallel.

3. Arrangement according to claim 1, wherein the vacuum pump and the secondary air pump are combined to one component.

4. Arrangement according to claim 3, wherein the two pumps are driven by a single electric motor.

5. A motor vehicle assembly comprising:
an air pump for pumping air to a vehicle combustion engine;
a vacuum operated brake assist unit;
a vacuum pump operable to generate vacuum for operation of the brake assist unit; and
a fluid pressure connection structure connecting said air pump to said brake assist unit to thereby provide additional vacuum pressure to the brake assist unit predetermined during vehicle operating conditions.

6. A motor vehicle assembly according to claim 5, wherein said predetermined vehicle operating conditions include cold starting of a vehicle engine.

7. A motor vehicle assembly according to claim 5, wherein the air pump and vacuum pump are connected in parallel.

8. A motor vehicle assembly according to claim 5, wherein the air pump and the vacuum pump are housed in a common house.

9. A motor vehicle assembly according to claim 8, wherein the air pump and the vacuum pump are driven by a single electric motor.

10. A motor vehicle assembly according to claim 9, wherein said predetermined vehicle operating conditions include cold starting of a vehicle engine.

11. A method of operating vehicle brakes on a motor vehicle having:
a vacuum operated brake assist unit;
a brake vacuum pump operable to generate vacuum pressure for operating the brake assist unit; and
an air pump operable to pump air for vehicle engine operations,
said method comprising selectively connecting the air pump with the brake assist unit to provide further vacuum pressure in addition to the vacuum pressure from the brake vacuum pump.

12. A method according to claim 11, wherein said selectively connecting the air pump is carried out during cold start of a vehicle engine.
